(19) United States
(12) Patent Application Publication
(10) Pub. No.: US 2005/0016039 A1
(43) Pub. Date: Jan. 27, 2005

(54) Signage holder

(76) Inventor: Brian Abramson, Brampton (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/626,648

(22) Filed: Jul. 25, 2003

(51) Int. Cl. G09F 7/02

(52) U.S. Cl. 40/611.01

(57) ABSTRACT

A signage holder for mounting to the front of a retail shelf. The signage holder has a spine extending in a longitudinal direction along a substantially vertical plane. Display retainers for holding different types of sign mounts, such as peg plates and cards, are mounted to the front face of the spine. A flange is detachably mounted to the spine, a portion of which extends rearwardly of the spine in a substantially horizontal plane. A pair of bumpers are mounted to the front face of the spine and extend forwardly of the display retainer. One of the bumpers is provided with a wire channel to allow the signage holder to be suspended from a wire.

### FIELD OF THE INVENTION

This invention relates to display devices, and particularly relates to signage holders and information display devices which are used to display and hold product information display signage at retail stores.

### BACKGROUND OF THE INVENTION:

Display devices are commonly used by retailers to display product information. Display devices are most suitable for products in which a substantial description of product features and specifications needs to be delivered to customers. Such products may include various electronic devices, automobile accessories, machinery and tools. At the same time, the use of display devices also permits an attractive display of product advertisements.

The field of display devices is indeed a crowded art and encompasses a wide variety of differing embodiments. In general, a display device comprises at least one display card or poster and may include a transparent panel which overlies at least one display card. Product information display cards provide specific information about the particular merchandise product displayed adjacent to the display card. The product information shown on the display card may be in the form of written descriptions, photos, graphic arts or any combination thereof. Typically, a display device is mounted on the front edge region of a shelving unit such that customers have ready visual access to the product information on the display card.

Another display device is known as a “peg plate”. Peg plates have a generally flat front and are generally attached to the front of a plastic or metal “peg”, on which product ????? is hung and which plugs into the industry-standard backboard called peg board. Peg plates may display information such as product price directly on the front surface of the plate or they may act as mounts onto which one of a variety of signage holders may be attached.

Peg plate signage holders and display cards may be mounted to an elongated beam face anchor which is attached to the front surface of a store shelf. The beam face anchor will often have longitudinal attachments into which display cards may be inserted. Alternatively, the beam face anchor may have mating attachments onto which a peg plate signage holder may slide. If the peg plate signage holder is flexible, it may even snap onto the attachments.

One of the main difficulties associated with beam face anchors is their installation onto a store shelf. The beam face anchor may be many feet long and difficult to evenly align and mount level with the shelf. Another difficulty associated with beam face anchors is that the sign attachments have, by necessity, very small cross-sections. As a result, they are prone to damage from passing shopping carts, forklifts etc. A third difficulty is the multiplicity of retail industry standard display devices. In some situations, a store may wish to use a peg plate for its versatility and durability, while in other situations, the store may wish to use display cards to provide product information.

Accordingly there is a need for a beam face anchor which can be installed and levelled easily, retain a variety of industry standard display devices and protect the sign attachments from inadvertent damage.

### SUMMARY OF THE INVENTION

In accordance with one aspect of the present invention, there is provided an information display support device.

The information display system has a spine extending in a longitudinal direction along a substantially vertical plane. The spine has a front face and a rear face and at least one display retainer is mounted to the spine. A flange is detachably mounted to the spine, a portion of which extends rearwardly of the spine in a substantially horizontal plane.

In another embodiment of the present invention, the flange has a first section and a second section. The first section is mounted to and generally aligned with an upper portion of the spine. The second section is connected at a generally right angle to the first section.

In a further embodiment of the present invention, the flange is mounted to the spine along a tear line. In order to form this tear line, the tear line may have a substantially thinner cross-section than the flange and the spine.

In yet another embodiment of the present invention, the information display system may also have at least one bumper mounted to the spine. The bumper is mounted such that it extends forwardly of the display retainer.

In yet a further embodiment, the information display system may also have at least one downwardly-facing longitudinally-extending channel. The channel is adapted to receive a longitudinally extending support member.

In a still further embodiment, a second display retainer is mounted to the front face of the spine. The second display retainer has a first groove and a second groove. The first groove is adapted to receive and retain the upper edge of a generally planar sign mount while the second groove is adapted to receive and retain the lower edge of a generally planar sign mount.

In another aspect of the present invention, the information display system has a spine extending in a longitudinal direction along a substantially vertical plane. The spine has a front face and a rear face and at least one display retainer is mounted to the front face. A first bumper is mounted to the spine such that it extends forwardly of the at least one display retainer.

In another embodiment, the first bumper is mounted proximate to one of an upper end of the spine and a lower end of the spine.

In still another embodiment, the system includes a second bumper mounted to the spine such that it extends forwardly of the at least one display retainer.

In a further embodiment, the first bumper is mounted proximate to the upper end and the second bumper is mounted proximate to the lower end.

In a still further embodiment, the first and second bumpers extend longitudinally along the spine and the at least one display retainer is mounted between the first bumper and the second bumper.

In yet another embodiment, the first bumper is mounted proximate to an upper end of the spine and is provided with a downwardly-facing channel. The channel is adapted to receive a longitudinally extending support member.

In a yet further embodiment the first bumper is provided with a downwardly-facing channel and the second bumper is provided with an upwardly-facing channel.

In another embodiment, the first bumper extends longitudinally along the spine.

In a further aspect of the present invention, the information display system has a spine extending in a longitudinal direction along a substantially vertical plane. The spine has a front face and a rear face and at least one display retainer mounted to the front face. A channel member is mounted to one of the front face and the rear face of the spine. The channel has a downwardly-facing longitudinally-extending channel and is adapted to receive a longitudinally extending support member.

In another embodiment of the present invention, the channel member is mounted to the front face of the spine.

In yet another embodiment, the channel has a generally V-shaped cross-section.

In still another embodiment, the channel member extends forwardly of the at least one display retainer.

In a further embodiment, the channel member has a forwardly extending upper section mounted to the spine and a downwardly extending forward section connected to a front end of the upper section.

In a yet further embodiment, the system also has a downwardly extending middle section affixed to the upper section between the spine and the front section. The channel is defined by the second section, the upper section and the front section.

In a still further embodiment, the system also includes a lower bumper mounted to the spine. The lower bumper has an upwardly-facing lower sign channel.

Optionally, the second section of the channel member, the middle section of the channel member and the spine define a downwardly-facing upper sign channel. The upper sign channel is adapted to receive an upper edge of a generally planar sign mount and the lower sign channel is adapted to receive a lower edge of the generally planar sign mount.

In a still further variation of the present invention, an information display system for displaying information on sign mounts includes a longitudinal spine with a front face and a rear face. A first display retainer is mounted to the front face of the spine and is adapted to receive a sign mount with a C-shaped cross-section. A second display retainer is mounted to the front face of the spine. The second display retainer has a first groove and a second groove. The first groove is adapted to receive and retain the upper edge of a generally planar sign mount while the second groove is adapted to receive and retain the lower edge of a generally planar sign mount.

In another embodiment, the first display retainer includes an upper first retainer portion and a lower first retainer portion. The upper first retainer portion is adapted to receive a downwardly facing portion of the sign mount while the lower retainer portion is adapted to receive an upwardly facing portion of the sign mount.

In a further embodiment, the second display retainer includes an upper second retainer portion and a lower second retainer portion. The first groove is provided in the upper second retainer portion while the second groove is provided in the lower second retainer portion.

In a yet further embodiment, the upper second retainer portion and the lower second retainer portion extend forwardly of the first display retainer.

In yet another embodiment, the upper first retainer portion is integral with the upper second retainer portion while the lower first retainer portion is integral with the lower second retainer portion.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a perspective view of an information display device with a tear-away flange hanging on a support wire in accordance with the present invention;

FIG. 2 is an end view of the information display device of FIG. 1 with the tear-away flange mounted to a shelf edge or support;

FIG. 3 is an end view of the information display device of FIG. 1 with the tear-away flange removed and in which a first sign is installed;

FIG. 4 is an end view of the information display device of FIG. 1 with the tear-away flange removed and in which a peg plate signage holder is installed;

FIG. 5 is an end view of the information display device of FIG. 1 with the tear-away flange removed and in which a third sign is installed;

FIG. 6 is an end view of the information display device of FIG. 1 with the tear-away flange removed and in which a small sign holder is installed; and

FIG. 7 is a cutaway of section “A” of the information display device of FIG. 1 mounted on a suspended wire.

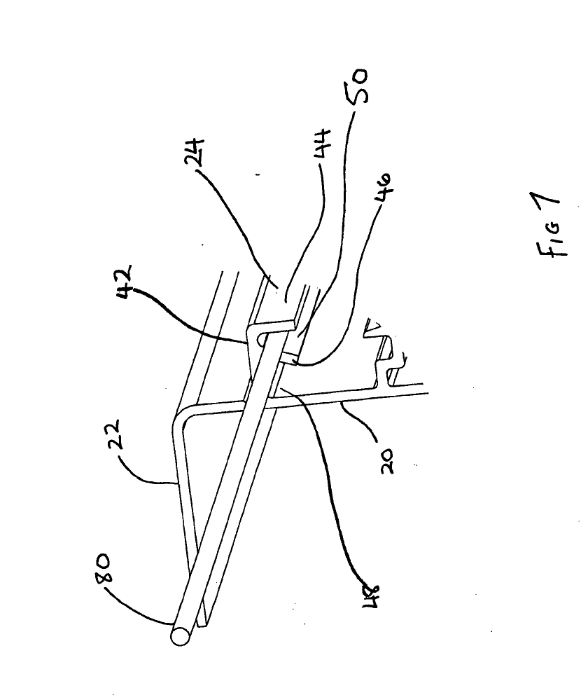

### DETAILED DESCRIPTION

The novel features which are believed to be characteristic of the present invention, as to its structure, organization, use and method of operation, together with further objectives and advantages thereof, will be better understood from the following discussion.

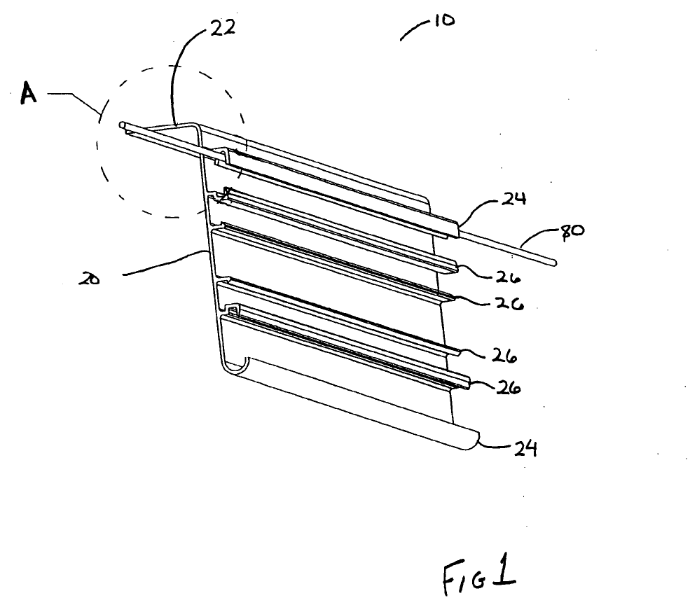

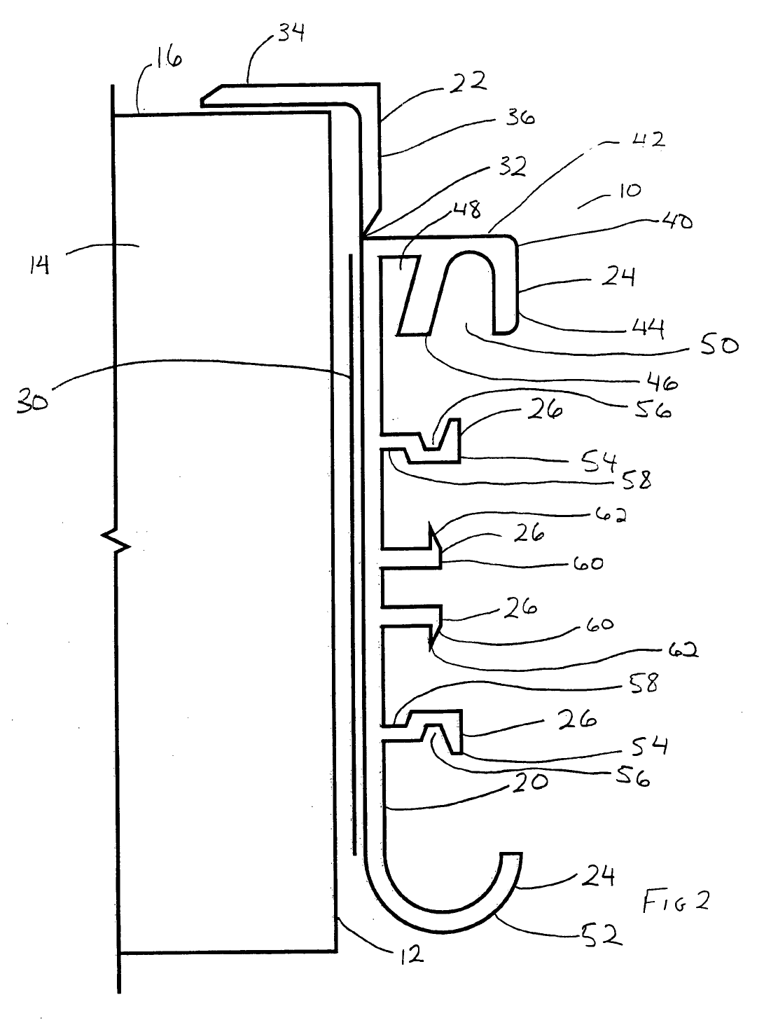

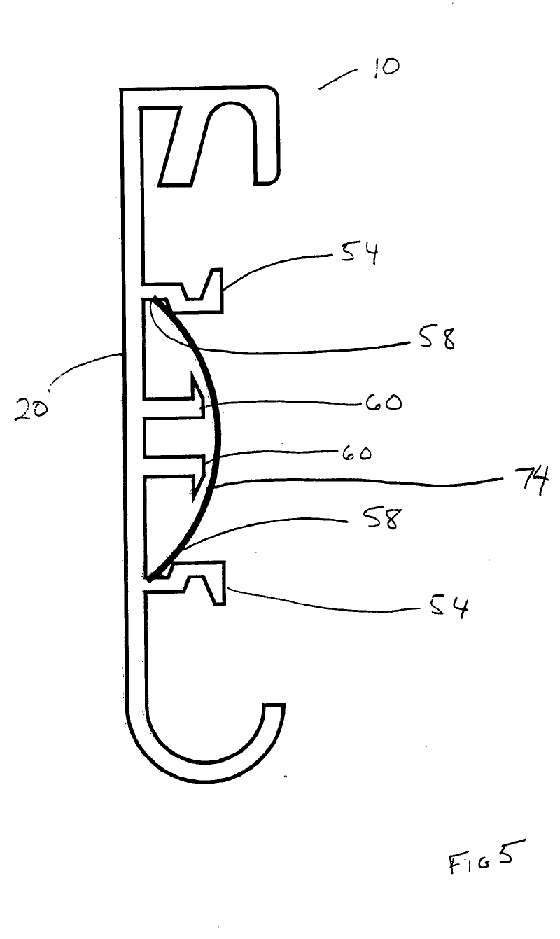

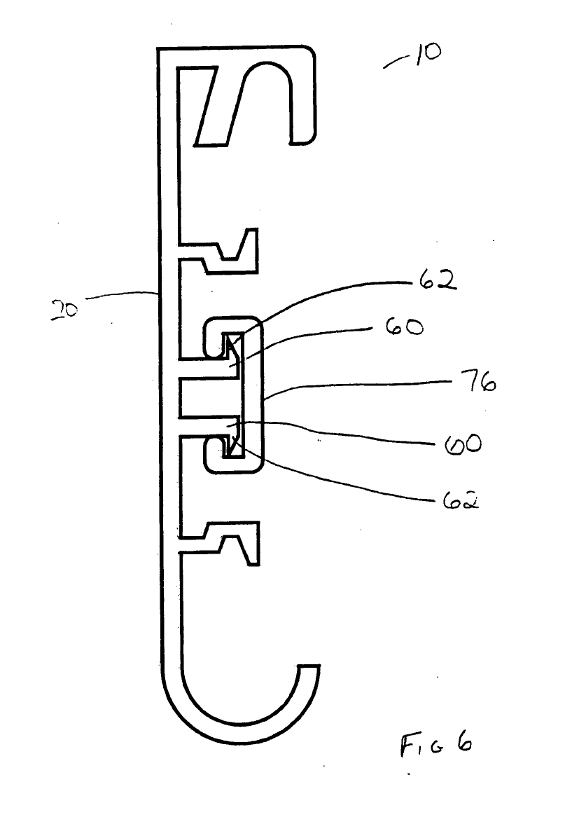

FIGS. 1 and 2 show a signage holder or information display system in the nature of beam face anchor 10 in accordance with present invention. Beam face anchor 10 is adapted to be affixed to the substantially planar front shelf surface 12 of a shelf support or shelf 14. Shelf 14 has a planar upper shelf surface 16 which lies in a generally horizontal plane and front shelf surface 12 depends vertically downwardly from upper shelf surface 16. Beam anchor 10 is composed of spine 20, tear-away flange 22, bumpers 24 and display retainers in the nature of sign attachments 26. FIGS. 2 through 6 show exaggerated bumpers and sign attachments.

Spine 20 is an elongated, generally flat rectangular member which attaches to front shelf surface 12 by means of an attachment. Spine 20 extends longitudinally along a substantially vertical plane. While a number of attachments are known in the art, one preferred method is the use of an elongated strip of double sided tape 30, one side of which is attached to the rear surface or face of spine 20, the other of which is attached to front shelf surface 12.

Tear-away flange 22 is an elongated member having an L-shaped cross section which is attached to the upper end of spine 20 along a tear line 32. Tear line 32, as shown in cross-section in FIG. 2, is a portion which is significantly thinner, and thus weaker, than spine 20 and tear-away flange 22.

Tear-away flange 22 has a first section or flat upper flange portion 34 which lies in a horizontal plane and is mounted generally flat against upper shelf surface 16 of shelf 14. A second section in the nature of lower flange portion 36 lies in a generally vertical plane and is coplanar with spine 20. Lower flange portion 36 depends downwardly from, and generally perpendicular to, upper flange portion 34. Thus, when beam face anchor 10 is mounted to shelf 14, upper flange portion 34 abuts upper shelf surface 16 while lower flange portion 36 lies against front shelf surface 12.

With respect to the description of the bumpers and sign attachments, the words “inner”, “inside” and “inwardly” shall refer to positions or orientations towards the longitudinal centre-line of spine 20, while the words “outer”, “outside” and “outwardly” shall refer to positions or orientations away from the longitudinal centre-line of spine 20.

A pair of bumpers 24 are mounted to the front face of spine 20. Bumpers 24 serve to protect sign attachments 26 from persons or objects which may inadvertently strike beam face anchor 10. Upper bumper 40 extends horizontally forwardly of the upper edge of spine 20 and then curves inwardly. Upper bumper 40 thus presents an upper bumper surface 42 in an upper section and a forward section in the nature of front bumper surface 44 which serve to protect the rest of beam face anchor 10 from objects which may strike from above beam face anchor 10 or from the front of beam face anchor 10 respectively. Upper bumper 40 is also provided with an inner surface from which a middle section or channel divider 46 depends on an angle both inwardly and rearwardly. Channel divider 46, upper bumper 40 and spine 20 define a groove or inner bumper channel 48, while channel divider 46 and the frontmost portion of upper bumper 40 define a generally V-shaped wire channel 50. Wire channel 50 is adapted to receive a length of wire 80 (preferably a standard sign hanging wire of 1/16″ diameter) which is longer than beam face anchor 10, such that beam face anchor 10 could hang from wire 80. Wire 80 preferably has a cross-sectional area such that it does not extend completely into uppermost portion of wire channel 50. As a result, due to the frictional forces and resulting tight fit of wire 80 within wire channel 50, beam face anchor 10 is less likely to slide longitudinally along the wire.

Lower bumper 52 is similar to upper bumper 40 except that it extends forwardly and then upwardly of spine 20 and is not provided with a channel divider.

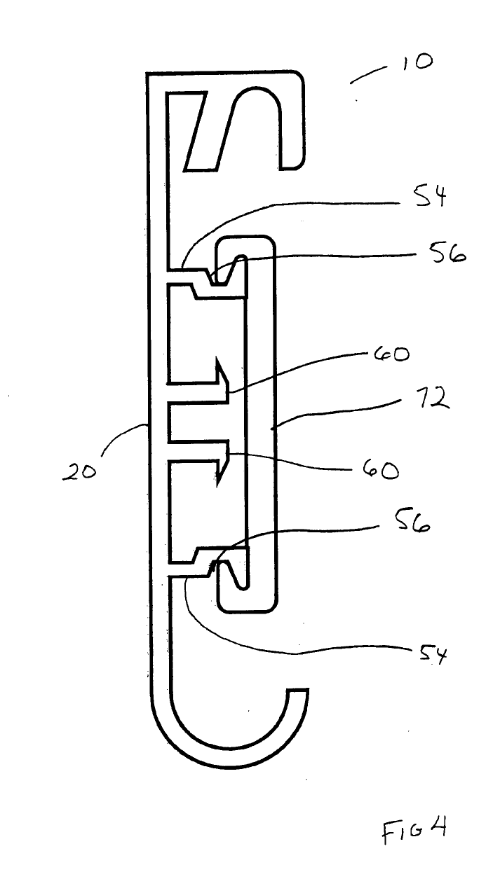

A pair of sign attachments in the nature of outer sign guides 54 are mounted to the front face of spine 20 between upper bumper 40 and lower bumper 52. Outer sign guides 54 are mounted such that they are identical but opposed to one another. As shown in FIG. 4, outer sign guides 54 have outer grooves 56 on the outer surfaces thereof which are adapted to receive the edges of a longitudinally extending peg plate signage holder with a C-shaped cross-section. In addition, outer sign guides 54 are provided with inner grooves 58 at the inner junction of outer sign guides 54 and spine 20.

A second pair of opposed attachments in the nature of inner sign guides 60 extend forwardly of spine 20 and lie inwardly of outer sign guides 50. Inner sign guides 60 extend horizontally forwardly of spine 20. An outwardly extending vertical lip 62 extends from the forwardmost end of each of inner sign guides 60. Inner sign guides 60 are adapted to receive a smaller sign mount with a C-shaped cross-section which wraps about lips 62.

Beam face anchor 10 is generally formed using an extrusion process and may be cut to any longitudinal length. Tear line 32 may be formed within beam anchor 10 during the extrusion process or it may be formed later by running beam face anchor 10 through a secondary process such as a pinwheel cutter, a roller or an embosser.

In atypical application of the present invention, beam anchor 10 is mounted to shelf 14 by aligning upper flange portion 34 of tear-away flange 22 on upper shelf surface 16 of shelf 14 and aligning lower portion of tear-away flange 22 on front shelf surface 12 of shelf 14. Prior to mounting beam anchor 10, the backing of double-sided tape 30 is removed. The alignment of upper portion 34 with upper shelf surface 16 ensures that beam face anchor 10 is mounted level with shelf 14. After beam face anchor 10 is aligned with shelf 14, spine 20 is pressed onto front shelf surface 12 to ensure that spine 20 adheres to front shelf surface 12. Preferably beam anchor 10 is sized to cover front surface 12 of a retail shelf or shelf support.

After beam face anchor 10 is adhered to front shelf surface 12, tear-away strip 22 can be removed by simply pulling the strip from one of its longitudinal ends. Tear-away strip 22 will detach itself from spine 20 along tear line 32 as it has already been weakened. Preferably, no additional weakening of tear line 32 is required and tear-away strip may be pulled by hand. Now that beam anchor 10 is mounted level with shelf 14, tear-away strip 22 is no longer needed and may be discarded.

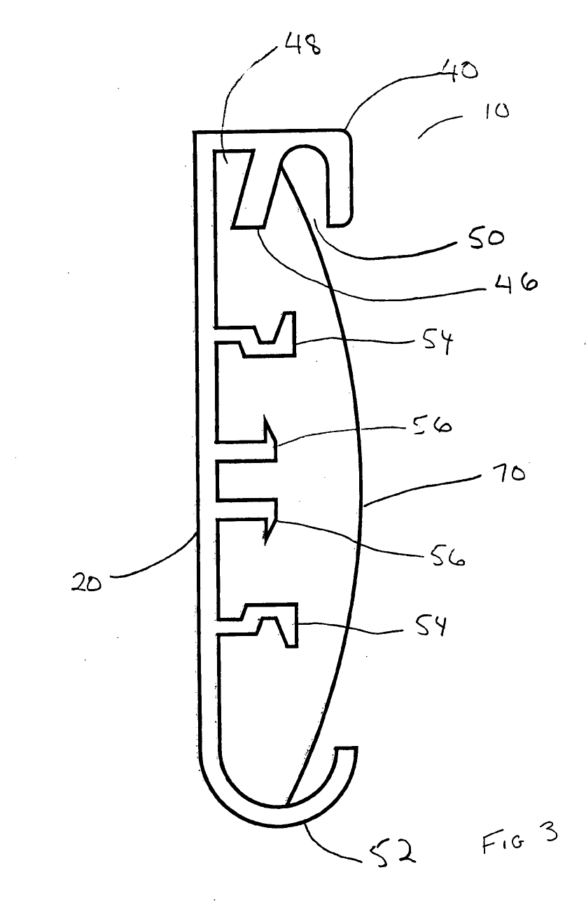

After tear-away strip 22 is removed, four different types of signs or signage holders may be mounted thereon. The first sign type is a generally planar sign mount in the nature of flexible rectangular card 70 with upper and lower edges. Card 70 may be bowed by the user, such that the upper and lower edges are brought closer together, and inserted between upper bumper 40 and lower bumper 52. The upper edge of card 70 may be inserted into either inner bumper channel 48 or wire channel 50 as shown in FIG. 3. The lower edge of card 70 will abut the sign channel in the inner surface or groove of lower bumper 52. The bowing action of card 70 serves two purposes. First, it provides the necessary clearance to avoid outer sign guides 54 and inner sign guides 60. Second, the bowing acts to press the edges of card 70 against the inner surfaces of bumpers 24, thus keeping card 70 in place. As a result, the height of the sign is preferably slightly greater than the vertical distance between the inner surfaces of bumpers 24. In this fashion bumpers 24 also act as display retainers.

The second form of sign which may be attached to beam face anchor 10 is a larger display board or peg plate signage holder 72 which may be mounted about outer sign guides 50 as shown in FIG. 4. Peg plate signage holder 72 may contain display information or may be a sign mount to which display information is attached. Peg plate signage holder 72 may be mounted by inserting it over outer sign guides 50 at one of the longitudinal ends of beam face anchor 10 and sliding it to the desired position. Optionally, peg plate signage holder 72 may be mounted by simply snapping it onto outer sign guides 50. If peg plate signage holder 72 displays information which refers to objects on shelf 14, when the objects are moved to another location on the shelf, peg plate signage holder 72 can slide to a new position. Removing peg plate signage holder 72 is similarly straightforward as the user can slide the sign off the longitudinal end of beam face anchor 10 or simply snap peg plate signage holder 72 off outer sign guides 54. Preferably, outer sign guides 54 are sized to accept industry standard 1.375″ high peg plate signage holders as used by major retailers. In addition, a hanging sign having a rear lip which can hook onto outer groove 56 of upper outer sign guide 50 may be used.

The third form of display is similar to card 70. A flexible rectangular card 74 could be mounted to beam face anchor 10 by inserting the upper and lower edges of card 74 into inner grooves 54 such that the sign bows fowardly slightly. Much as with card 70, the height of card 74 is preferably slightly greater than the vertical distance between inner grooves 54. Preferably, inner grooves are positioned such that they allow for industry standard 1.25″ rectangular cards to be inserted and be sufficiently bowed to clear inner sign guides 60, although the distance between inner grooves 54 can be altered to receive other desired sizes.

The fourth form of display is similar to peg plate signage holder 72. A sign mount 76, as shown in Figure X, can be mounted about inner sign guides 60, similar to the mounting of peg plate signage holder 72 to outer sign guides 50. Preferably, inner sign guides 60 are positioned such that they may accept the mounting plate of VidPro™ ⅝″ anchors or SnapOn™ connectors, although other sizes may be used.

The four different forms of signs may be used simultaneously on a single beam face anchor 10, allowing a retailer to create custom displays. Depending on the horizontal clearance between the various form of signs, two more different forms of signs may be able to slide past one another as the signs are positioned, installed or removed.

In addition, bumpers 24 act to protect outer and inner sign guides 50 and 60, respectively, from passers-by, carts and other items which may impact beam anchor 10. Preferably, bumpers 24 extend forwardly of sign attachments 26.

Also, beam face anchor 10 need not be mounted to a shelf. There are a wide variety applications for hanging signs on wires. A length of beam face anchor 10 may be hung by placing wire channel 50 over a suspended wire 80 or other such longitudinally extending support member. Then, one or more of the sign displays may be mounted to beam face anchor 10.

As well, beam face anchor 10 need to be mounted to the front of a horizontal shelf. Beam face anchor 10 may be also be applied vertically to a surface such as a shelf edge or on a pallet racking shelf installation. Naturally, in such a configuration, the various signs which can be mounted to beam face anchor 10 will need to be fitted such that they do not slide downwards due to gravitational forces.

In addition, different bumper systems can be used with the present beam face anchor. For example, bumpers may be oriented in a vertical direction at intervals along the spine. The bumpers would continue to protect the display attachments and, depending on the distance and orientation of successive bumpers, could serve to hold card signs.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially vertical is intended to mean perpendicular to a horizontal orientation, or nearly so, and/or exhibiting characteristics associated with a general vertical element or orientation.

1. An information display system comprising:
(a) a spine extending in a longitudinal direction along a substantially vertical plane, said spine having a front face and a rear face;
(b) at least one display retainer mounted to said spine; and
(c) a flange detachably mounted to said spine, a portion of said flange extending rearwardly of said spine in a substantially horizontal plane.

2. An information display system as claimed in claim 1, wherein said flange has a first section and a second section, said first section being mounted to and generally aligned with an upper portion of said spine, said second section being connected at a generally right angle to said first section.

3. An information display system as claimed in claim 1, wherein said flange is mounted to said spine along a tear line.

4. An information display system as claimed in claim 3, wherein said tear line has a substantially thinner cross-section than said flange and said spine.

5. An information display system as claimed in claim 1, further comprising at least one bumper mounted to said spine, said bumper being mounted such that it extends forwardly of said at least one display retainer.

6. An information display system as claimed in claim 1, further comprising at least one downwardly-facing longitudinally-extending channel, said channel being adapted to receive a longitudinally extending support member.

7. An information display system as claimed in claim 1, further comprising a second display retainer mounted to said front face of said spine, said second display retainer having a first groove and a second groove, said first groove being adapted to receive and retain the upper edge of a generally planar sign mount, said second groove being adapted to receive and retain the lower edge of a generally planar sign mount.

8. An information display system comprising:
(a) a spine extending in a longitudinal direction along a substantially vertical plane, said spine having a front face and a rear face;
(b) at least one display retainer mounted to said front face; and
(c) a first bumper mounted to said spine, said first bumper being mounted such that it extends forwardly of said at least one display retainer.

9. An information display system as claimed in claim 8, wherein said first bumper is mounted proximate to one of an upper end of said spine and a lower end of said spine.

10. An information display system as claimed in claim 8, further comprising a second bumper mounted to said spine such that it extends forwardly of said at least one display retainer.

11. An information display system as claimed in claim 10, wherein said first bumper is mounted proximate to said upper end and said second bumper is mounted proximate to said lower end.

12. An information display system as claimed in claim 10, wherein said at least one display retainer and said first and second bumpers extend longitudinally along said spine, said at least one display retainer being mounted between said first bumper and said second bumper.

13. An information display system as claimed in claim 8, wherein said first bumper is mounted proximate to an upper end of said spine, said first bumper being provided with a downwardly-facing channel, said channel being adapted to receive a longitudinally extending support member.

14. An information display system as claimed in claim 8, wherein said first bumper is provided with a downwardly-facing channel and wherein said second bumper is provided with an upwardly-facing channel.

15. An information display system as claimed in claim 8, wherein said first bumper extends longitudinally along said spine.

16. An information display system for mounting to a longitudinally extending support member, the information display system comprising:
(a) a spine extending in a longitudinal direction along a substantially vertical plane, said spine having a front face and a rear face;
(b) at least one display retainer mounted to said front face; and
(c) a channel member mounted to one of said front face and said rear face of said spine, said channel member having a downwardly-facing longitudinally-extending channel, said channel being adapted to receive the support member.

17. An information display system as claimed in claim 16, wherein said channel member is mounted to said front face of said spine.

18. An information display system as claimed in claim 16 wherein said channel has a generally V-shaped cross-section.

19. An information display system as claimed in claim 17 wherein said channel member extends forwardly of said at least one display retainer.

20. An information display system as claimed in claim 17, wherein said channel member has a forwardly extending upper section mounted to said spine and a downwardly extending forward section connected to a front end of said upper section.

21. An information display system as claimed in claim 20, further comprising a downwardly extending middle section affixed to said upper section between said spine and said front section, said channel being defined by said middle section, said upper section and said front section.

22. An information display system as claimed in claim 21, wherein said channel has a generally V-shaped cross-section.

23. An information display system as claimed in claim 21, further comprising a lower bumper mounted to said spine, said lower bumper having an upwardly-facing lower sign channel.

24. An information display system as claimed in claim 23, wherein said second section of said channel member, said middle section of said channel member and said spine define a downwardly-facing upper sign channel, said upper sign channel being adapted to receive an upper edge of a generally planar sign mount, said lower sign channel being adapted to receive a lower edge of the generally planar sign mount.

25. An information display system for displaying information on sign mounts, the information display system comprising:
(a) a longitudinal spine having a front face and a rear face;
(b) a first display retainer mounted to said front face of said spine, said first display retainer being adapted to receive a sign mount having a C-shaped cross-section; and
(c) a second display retainer mounted to said front face of said spine, said second display retainer having a first groove and a second groove, said first groove being adapted to receive and retain the upper edge of a generally planar sign mount, said second groove being adapted to receive and retain the lower edge of a generally planar sign mount.

26. An information display system as claimed in claim 25, wherein said first display retainer includes an upper first retainer portion and a lower first retainer portion, said upper first retainer portion being adapted to receive a downwardly facing portion of the sign mount, said lower retainer portion being adapted to receive an upwardly facing portion of the sign mount.

27. An information display system as claimed in claim 26, wherein said second display retainer includes an upper second retainer portion and a lower second retainer portion, said first groove being provided in said upper second retainer portion and said second groove being provided in said lower second retainer portion.

28. An information display system as claimed in claim 27, wherein said upper second retainer portion and said lower second retainer portion extend forwardly of said first display retainer.

29. An information display system as claimed in claim 27, wherein said upper first retainer portion is integral with said upper second retainer portion and wherein said lower first retainer portion is integral with said lower second retainer portion.
